(19) United States
(12) Patent Application Publication
(10) Pub. No.: US 2010/0268792 A1
(43) Pub. Date: Oct. 21, 2010

(54) VENDING MACHINE WITH INTERACTIVE DISPLAY

(75) Inventors: Glenn Butler, Holliston, MA (US); Scott Hudis, Stillwater, MN (US); Anton Rakushkin, Sharon, MA (US); Leonid Filatov, Sudbury, MA (US)

Correspondence Address: DOCKET CLERK, P.O. DRAWER 800889, DALLAS, TX, 75380, US

(73) Assignee: CRANE MERCHANDISING SYSTEMS, INC., Bridgeton, MO (US)

(21) Appl. No.: 12/759,592

(22) Filed: Apr. 13, 2010

Related U.S. Application Data
(60) Provisional application No. 61/168,872, filed on Apr. 13, 2009.

(51) Int. Cl. G06F 17/00; G06F 3/048; G06F 15/16; G06F 21/00; G06Q 30/00; G06Q 40/00

(52) U.S. Cl. 709/217; 700/232; 715/810; 726/4; 700/94; 705/14.66

(57) ABSTRACT

A system and method are presented that include a remote server and a vending machine. The remote server transfers media control and content information via a communication link. The information includes an advertisement that relates to at least one product available for vending from the vending machine. The vending machine includes a product storage area, an interactive display, and a controller. The product storage area stores products available for sale from the vending machine. The interactive display receives a user selection of a product to vend. The controller receives the media information and displays graphical information relating to the advertisement using the interactive display, according to the media information. The controller receives a product selection signal from the interactive display, representing a product to vend, and dispenses a product from the product storage area according to the product selection signal.

### CROSS-REFERENCE TO RELATED APPLICATIONS AND CLAIM OF PRIORITY

The present application is related to U.S. Provisional Patent Application No. 61/168,872, filed Apr. 13, 2009, entitled “VENDING MACHINE WITH INTERACTIVE DISPLAY”. Provisional Patent Application No. 61/168,872 is assigned to the assignee of the present application and is hereby incorporated by reference into the present application as if fully set forth herein. The present application hereby claims priority under 35 U.S.C. §119(e) to U.S. Provisional Patent Application No. 61/168,872.

### TECHNICAL FIELD

This disclosure is generally directed to consumer product vending machines and, more particularly, to systems and methods for controlling interfaces and displays in vending machines.

### BACKGROUND

A vending machine is a machine that provides various snacks, beverages and other products to consumers by vending products without a cashier. Items sold via vending machines can vary by country and region. Vending machines typically utilize a push button interface that is capable of accepting money in paper, coin or credit/debit card form. For example, a consumer may insert coins into a coin acceptor or dollar bills into a bill validator, or a combination of the two. Thereafter, the consumer typically makes a product selection by entering a product identifying code into a keypad on the face of the vending machine. If the amount of money recognized by the machine equals or exceeds the amount of money required to purchase the selected product, the machine proceeds to vend the product to the consumer. However, if the consumer has not entered enough money, or the machine does not recognize the entry of enough money, no product will be vended to the consumer.

### SUMMARY

In one embodiment, a system includes a remote server and a vending machine. The remote server is configured to transfer media information via a communication link. The media information includes media control information and media content information, including an advertisement that relates to at least one product available for vending from the vending machine. The vending machine includes a product storage area, an interactive display, and a controller. The product storage area is configured to store products available for sale from the vending machine. The interactive display is configured to receive a user selection of a product to vend. The controller is configured to receive the media information from the remote server via the communication link. The controller is also configured to display graphical information relating to the advertisement using the interactive display, where the graphical information is displayed according to the media information. The controller is further configured to receive a product selection signal from the interactive display, where the product selection signal represents the user selection of a product to vend. The controller is still further configured to dispense a product from the product storage area according to the product selection signal.

In another embodiment, a vending machine includes a product storage area, an interactive display, and a controller. The product storage area is configured to store products available for sale from the vending machine. The interactive display is configured to receive a user selection of a product to vend. The controller is configured to receive media information via a communication link. The media information includes media control information and media content information, including an advertisement relating to at least one product available for vending from the vending machine. The controller is also configured to display graphical information relating to the advertisement using the interactive display, where the graphical information is displayed according to the media information. The controller is further configured to receive a product selection signal from the interactive display representing the user selection of a product to vend. The controller is still further configured to dispense a product from the product storage area according to the product selection signal.

In still another embodiment, a method includes transferring media information from a remote server to a vending machine via a communication link. The media information includes media control information and media content information, including an advertisement relating to at least one product available for vending from the vending machine. The method also includes displaying graphical information relating to the advertisement using an interactive display of the vending machine, where the graphical information is displayed according to the media information. The method further includes receiving a product selection signal from the interactive display, where the product selection signal represents a user selection of a product to vend. The method also includes dispensing a product from a product storage area of the vending machine according to the product selection signal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings, in which:

FIG. 1 illustrates a simplified illustration of a vending machine according to embodiments of the present disclosure;

FIG. 2 illustrates a simplified block diagram of a vending machine controller according to embodiments of the present disclosure;

FIG. 3 illustrates an exemplary product delivery bucket for a vending machine according to embodiments of the present disclosure;

FIG. 4 illustrates a monetary door according to embodiments of the present disclosure;

FIG. 5 illustrates a monetary slide according to embodiments of the present disclosure;

FIG. 6 is a schematic system diagram of a vending machine network or system providing communications with and control of one or more remotely located vending machines according to one embodiment of the present disclosure;

FIG. 7 illustrates a simple block diagram of the computer subsystem according to embodiments of the present disclosure;

FIG. 8 illustrates a simple block diagram of an alternative embodiment providing an integrated vending machine controller and computer subsystem according to embodiments of the present disclosure; and

FIG. 9 illustrates a simplified electronic vending machine coin handling system according to one embodiment of the present disclosure.

### DETAILED DESCRIPTION

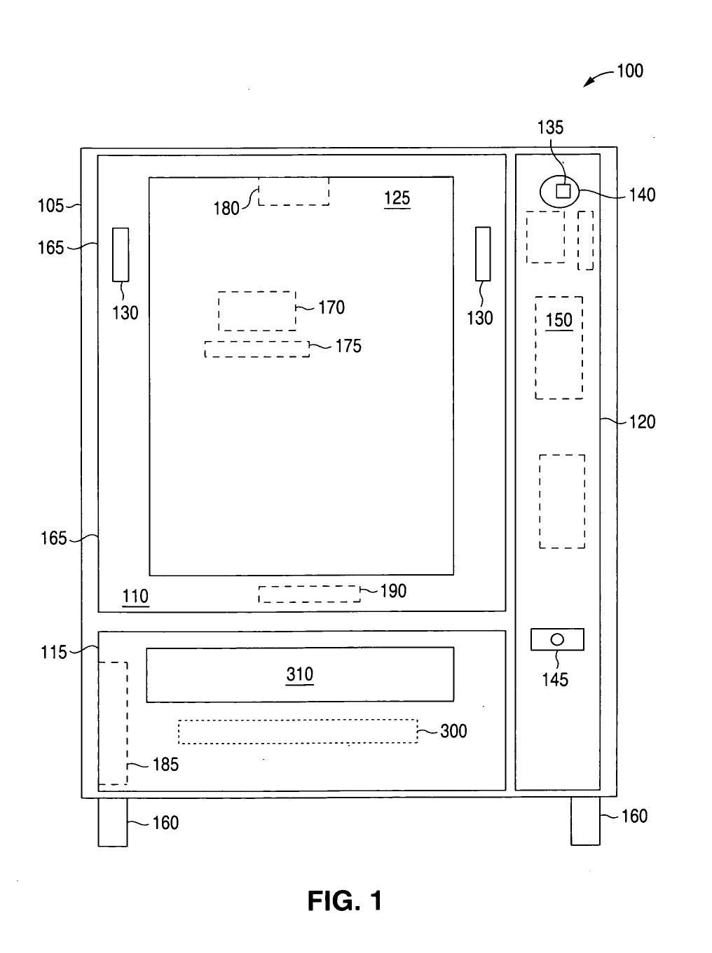

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine system and network.

The present disclosure provides a system and method providing an interactive display on a vending machine transaction. This disclosure also provides a system and method for providing, controlling, retrieving, storing, modifying and updating product and advertising information for display to a consumer through a vending machine user interface, such as a large touch-screen display (input/output device). This disclosure also provides a system and method for receiving multiple forms of payment in vending machine transactions, and collecting and transferring inventory information and any other information related to the vending machine or its operation, including information received from user interactions. This disclosure also provides systems and methods for transmitting and receiving (communicating) such product and advertising information and other information to and from device(s) located remotely and externally from the vending machines, such as a number of vending machines within a vending machine network.

FIG. 1 illustrates a simplified illustration of a vending machine 100 according to embodiments of the present disclosure. The embodiment of the vending machine 100 shown in FIG. 1 is for illustration only and other embodiments could be used without departing from the scope of this disclosure.

The vending machine 100 includes a cabinet 105 and a product storage area (not shown). The cabinet 105 includes a top wall, bottom wall, right side wall, left side wall, back wall, and front that collectively define a central cavity. The vending machine 100 includes a main door 110 pivotally connected to the cabinet 105, a product delivery door 115 pivotally connected to the cabinet 105 and a monetary door 120 on the front of the cabinet 105, as shown. The monetary door 120 may be pivotally connected to the cabinet or attached via rail system such that the monetary door 120 slides from the cabinet 105 to provide access to certain components within the vending machine 100. The main door 110 includes a display 125 incorporated and mounted therein or thereon, and having touch-screen or other user input capabilities.

One or more audio speakers 130 may be provided. Other input/output devices may be provided and included at various locations, as known to those skilled in the art. In some embodiments the vending machine 100 includes a camera 135 positioned proximate (e.g., behind) to an opening 140 in the monetary door 120. In some embodiments, a single lock 145 or multiple locks are included or incorporated to secure the monetary door 120, the main door 110, and/or the product delivery door 115 in a closed position.

In a manner known in the art, a first pair of wheels or casters 160 (or other support devices) is secured to a front edge portion of bottom wall to facilitate the positioning of vending machine 100. It will be understood that a second pair of wheels (not shown) may also be arranged on a rear portion of bottom wall.

The vending machine 100 includes a vending machine controller (VMC) 150 and a computer and display subsystem 170.

The VMC 150 is configured to direct (e.g., control) vending machine 100 functions during a vend operation or sequence, and further to control one or more components of the vending machine 100. The VMC 150 also can communicate with vending machine operators both locally and remotely.

The vending machine 100 typically includes a number of products for sale in a vending operation. The products are stored in product storage trays (not shown) within the vending machine product storage area. The product storage area is provided to hold products until a vending operation is requested and performed. Towards that end, storage area is provided with a plurality of product storage trays such as, but not limited to a plurality of vertically extending column walls that, together with right and left side walls, form a plurality of column or stack areas. In one embodiment, stack areas constitute single stack columns. However, it should be understood that the present disclosure also encompasses vending machines having multi-stack columns. In some embodiments, the product storage area may be refrigerated or heated. The products may be stored in a stacked configuration where one product is stacked upon another of the same product. Additionally, the products may be stored in trays such that one product is positioned in front of another of the same product. Any suitable configuration and structure may be used for the product storage area and vending mechanics, including conventionally known apparatus and methods for the physical vending of a selected product.

The door 110, coupled to the housing of the vending machine 100 via a hinged joint 165, provides access to the product storage trays. The hinged joint 165 is located on a vertical edge of the door 110. The hinged joint 165 couples the door 110 to a portion of a vertical front edge of the cabinet 105. While the embodiment illustrated in FIG. 1 includes multiple doors, other embodiments may include a single door or additional doors. In the one embodiment shown, the main door 110 enables access to the product storage area (not shown) for stocking/re-stocking products to be vended. The entire structure of the main door 110 is positioned above the product delivery area (identified by 310).

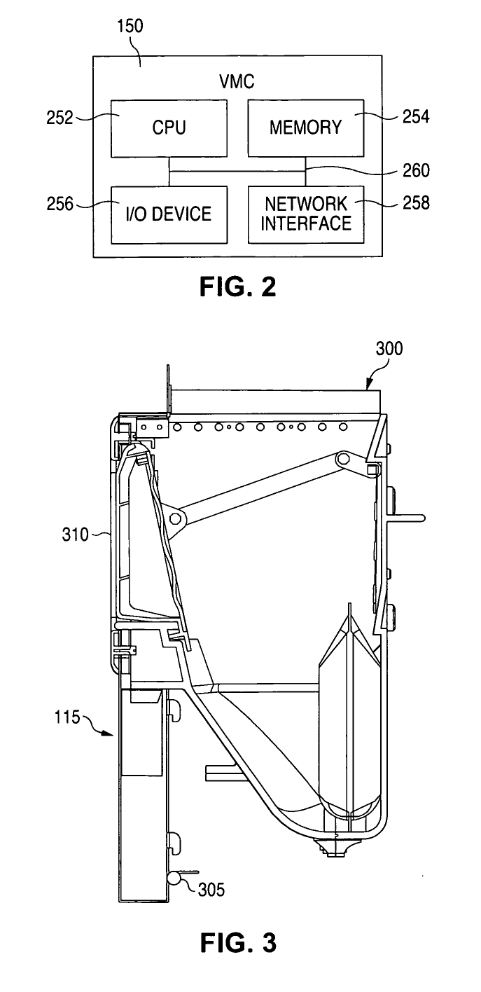

FIG. 2 illustrates a simplified block diagram of the VMC 150 according to embodiments of the present disclosure. The embodiment of the VMC controller 150 shown in FIG. 2 is for illustration only. Other embodiments of the VMC 150 may be used without departing from the scope of this disclosure.

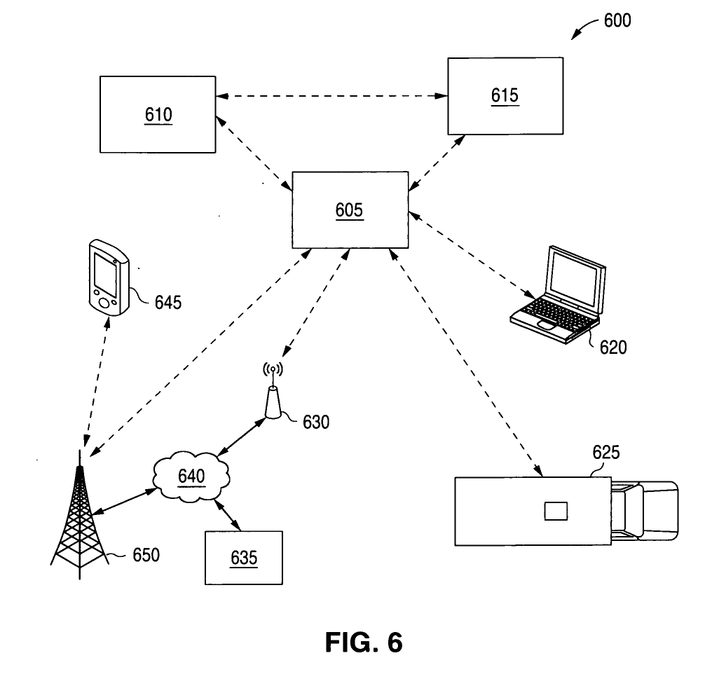

One embodiment of the VMC 150 incorporated within and utilized to operate and control the mechanical vend operation of the vending machine 100 is shown in FIG. 2. The VMC 150 may be a computer, or any other device capable of transmitting, processing, and/or receiving signals via wireless and/or wireline communication links. In a typical embodiment, the VMC 150 includes a central processing unit (“CPU”) 252, a memory unit 254, one or more input/output (“I/O”) devices 256, and a network interface 258. The network interface may be, for example, one or more network interface cards (NICs) that are each associated with a media access control (MAC) address. The components 252, 254, 256, and 258 are interconnected by one or more communication links 260 (e.g., a bus). It is understood that the VMC 150 may be differently configured and that each of the listed components may actually represent several different components. For example, the CPU 252 may actually represent a multi-processor or a distributed processing system; the memory unit 254 may include different levels of cache memory, main memory, hard disks, and remote storage locations; and the I/O device 256 may include monitors, keyboards, and the like. Alternatively, single components may be utilized for two or more of the components illustrated. The network interface 258 enables the VMC 150 to connect to a network, such as a wireline or wireless network as shown in FIG. 6.

Memory unit 254 includes programming instructions adapted to be utilized by the CPU 252 to direct the components of the vending machine 100 through vending operations, local and remote communications with operating personnel and display operations. Memory unit 254 is further adapted to store inputs received from the interactive display 125 for illustrations, such as, but not limited to a product selected via the interactive display 125.

The VMC 150 operates one or more product dispensing motors in the vending machine 100. The product dispensing motor can operate a slide mechanism to allow a first product to be released from the product storage tray and deposited within a product delivery bucket (discussed in further detail herein below) coupled to the product delivery door 115. Alternatively, the product dispensing motor can operate a helical coil that moves a product forward in the product storage tray such that the product is released from the product storage tray and deposited in the product delivery bucket. Alternatively, the product dispensing motor can operate a product capture device on a robotic arm. The product capture device slides along the robotic arm as the robotic arm moves the product capture device to a selected product. The product capture device removes the selected product from the product delivery tray. Thereafter, the product capture device slides along the robotic arm as the robotic arm moves the product capture device towards the product delivery bucket. Then, the product capture device places the selected product in the product delivery bucket for eventual access by the customer.

FIG. 3 illustrates an exemplary product delivery bucket for a vending machine according to embodiments of the present disclosure. The embodiment of the product delivery bucket 300 shown in FIG. 3 is for illustration only and other embodiments could be used without departing from the scope of this disclosure.

The vending machine 100 includes the product delivery door 115. The product delivery door 115 is coupled to the cabinet 105 of the vending machine 100 via a hinged joint 305. The hinged joint 305 is located on the bottom of front edge of the product delivery door 115. In some embodiments, the hinge joint 305 is located on a vertical side of the cabinet 105.

The vending machine 100 includes a product delivery bucket 300. The product delivery bucket 300 is located beneath the lowermost product storage trays. The product delivery bucket 300 is accessible by rotating the product delivery door 115 about the hinged joint 305. Products deposited within the product delivery bucket 300 are accessible via an access door 310. The access door 310 is located on a front surface of the product delivery door 115. As will be appreciated, other configurations and structures may be utilized for delivering the selected product from the storage area to an access area for customer retrieval of the vended product.

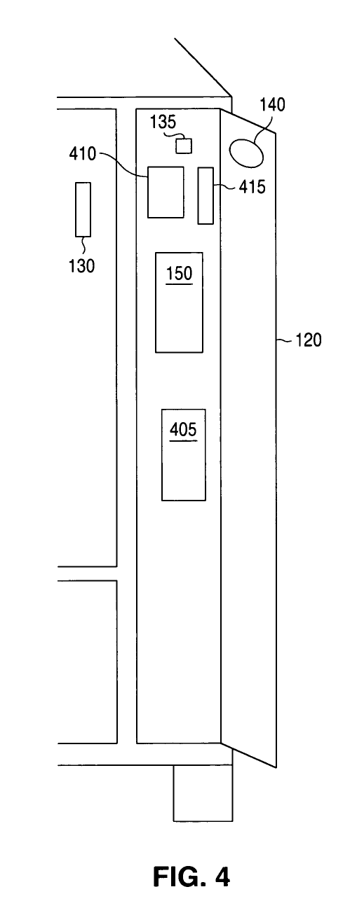

FIG. 4 illustrates a monetary door according to embodiments of the present disclosure. The embodiment of the monetary door 120 shown in FIG. 4 is for illustration only. Other embodiments of the monetary door 120 could be used without departing from the scope of this disclosure.

The monetary door 120 provides access to components within the vending machine 100. The monetary door 120 provides access to the VMC 150, a vending machine power supply 405 and a cabinet fan 410. In some embodiments, the monetary door includes the camera 135 positioned to capture images through the glass opening 140. In such embodiments, the monetary door 120 also provides access to a camera controller 415.

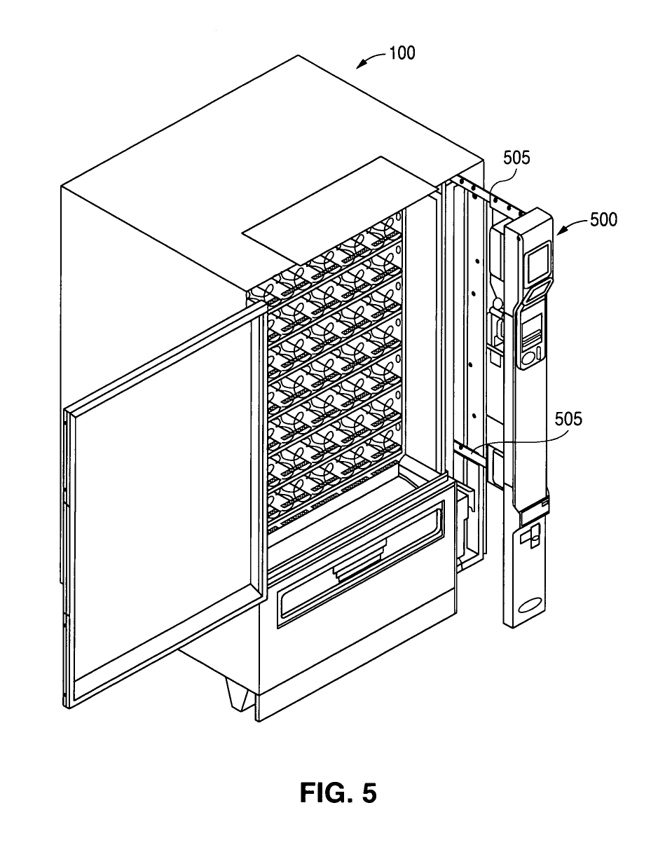

In some embodiments, illustrated in FIG. 5, the monetary door 120 is the face of a monetary slide 500, also referred to as a control carriage, configured to hold one or more of the components and controllers for use in the vending machine 100. The monetary slide 500 is attached to vending machine 100 cabinet 105 via a glide assembly 505. The glide assembly 505 enables the monetary slide 500 to slide forward, outward from the cabinet 105. Sliding the monetary slide 500 provides access to internal components of the vending machine 100, money collected by the vending machine 100, and a product delivery door latching mechanism (not specifically shown).

The product delivery door latching mechanism is an interlock that secures the product delivery door 115 in an upright, i.e., dispensing position. In order to open the product delivery door 115, an operator must first slide the monetary slide 500 forward, and operate the product delivery door latching mechanism to tilt the product delivery door 115 downward.

Referring back to FIG. 1, the vending machine 100 includes the display 125 having interactive capabilities and functionality. The interactive display 125 may be any suitable size (and may include multiple individual displays operating individually or integrated together), type and structure. Various conventional and commercially available displays may be utilized, provided the display portion (or the display unit) includes user interface capabilities. For example, the display 125 may be a liquid crystal display (LCD) or plasma display having user interface or input capabilities. In one specific embodiment, the display may be a 42″ or 46″ diagonal LCD (and may be positioned in any suitable orientation). It will be understood that illustration of the display as 42″ or 46″ is exemplary and many other diagonal (or height and length) sizes may be used without departing from the scope of this disclosure.

In some embodiments, the interactive display 125 is a touch screen having touch-screen capabilities. Therefore, the interactive display 125 is capable of receiving inputs from a user (e.g., customer) via the user touching one or more areas within the interactive display 125. In such embodiments, the vending machine 100 does not include a keypad for product selection. Instead, the interactive display 125 provides a keypad, graphic images and/or other icons or symbols enabling a customer to select a product or service from the vending machine 100, or otherwise enable users to interact with the vending machine 100 (such as for programming, maintenance, etc.).

The interactive display 125 is communicatively coupled to the computer subsystem 170 via a display controller 175. As will be appreciated, the computer and display controller subsystem 170 is, in one embodiment, a computer with a special or general-purpose processor and one or more controllers and supporting components. The computer and display subsystem 170 functions to control operation of the display 125 (via the display controller 175 which also controls operation of the interactive display 125). It will be appreciated that the display controller 175 may be a separate component or integrated with the computer subsystem 170. In addition, the speakers 130 are controlled by the computer subsystem 170, the display controller 175, an audio controller (not shown) or combination thereof. The display controller 175 includes functionality necessary to control processing and adjustment of images displayed on the interactive display 125.

In embodiments wherein the interactive display 125 is a touch screen, the interactive display 125 further is coupled to a touch screen controller 180 for receiving inputs from a user via the touch screen of the display 125. The touch screen controller 180 may be a separate component or integrated with the computer subsystem 170.

Though not shown, the vending machine 100 may include a microphone for receiving audible commands or input from a user positioned near the vending machine 100. In such manner, a user may input audible responses or commands which are converted and interpreted into a proper format to initiate a vending operation or for other purposes. For example, a visual or audible prompt or menu may be provided by the vending machine 100 to a user, the user may respond audibly (or via the touch screen), such as for selecting a product to vend, and the vending machine 100 may either vend the product or provide an additional prompt or menu to the user (e.g., visual representation of product audibly selected with request to confirm selected), and receive further user input (e.g., to confirm the selected product) and initiate the vend or other operation. In this configuration, the vending machine will include a speech recognition component that receives speech, converts the speech to another format which is utilized by the computer subsystem 170 or VMC 150 for processing and controlling the vending machine 100.

In some embodiments the vending machine 100 includes a number of customer account identification circuits (not shown). For example, the vending machine 100 includes a sensor adapted to read or sense a fingerprint, an eye scanner adapted to read a retinal image of the customer.

Power is provided to the interactive display 125 (and other components) via a main power supply and controller 185. Additionally, the main door 110 includes a door fan 190 for removing heat from the interactive display 125. As will be appreciated, during operation the interactive display 125 may generate a substantial amount of heat in within the cabinet 105 (particularly in the front near the display 125). This heat can be detrimental to the interactive display 125, other components in the vending machine 100, such as, but not limited the VMC 150 and the computer subsystem, as well as the products in the product storage trays. The door fan 190 and the cabinet fan 410 work singularly and in combination to remove heat from the interactive display 125. The door fan 190 and the cabinet fan 410 remove the heat towards an exterior portion of the cabinet 105.

In other embodiments, the VMC 150 or other controller may control a brightness of the interactive display 125 to reduce heat produced by the display. That is, the brightness of the interactive display 125 may be reduced in high ambient temperatures or when heat build up in the vicinity of the interactive display 125 is detected, in order to reduce heat produced by the display.

The computer subsystem 170 communicates with the VMC 150. The computer subsystem 170, in conjunction with the LCD display controller 175, controls the interactive display 125 using information stored in a memory (not shown) and information received via the VMC 150 to control images displayed in the interactive display 125 and to control sound broadcast via the speakers 130.

The interactive display 125 (and speakers) includes functionality providing a user interface for receiving and/or outputting information to a user (e.g., visual, audible, touch). This user interface provides a customer with the ability to select a product or service for a vend operation or otherwise interact with the vending machine to receive information or input information). For example, the user interface may visually display a number of images (static, dynamic) on the display 125 representative of products in the product storage area and available for selection and purchase. The customer selects a product by touching an image (or a specific location associated with the image) representing the desired product. This information (e.g., positional information of where the display was touched) is transmitted to the computer subsystem 170, which in turn, transmits information to the VMC 150 for performing a vend operation. Thereafter, the VMC 150 commences to operate the respective product dispensing motors and devices to vend the selected product.

FIG. 6 is a schematic system diagram of a vending machine system communication network 600 according to embodiments of the present disclosure. The vending machine communication network 600 shown in FIG. 6 is for illustration only and other embodiments and configurations could be used without departing from the scope of this disclosure.

The system 600 includes multiple vending machine 605, 610 and 615 shown in FIG. 6. These machines may include the same or similar structure and functionality described with respect to vending machine 100. Further, one or more of the vending machines may be a vending machine that does not include an interactive display.

In general, the vending machines 605, 610 and 615 communicate with one or more remote devices for various purposes. These remote devices may include one or more remote servers or other networked devices, vending machines, and/or portable/mobile network devices (such as a hand-held device).

Vending machines 605, 610 and 615 according to one embodiment of the present disclosure communicate with each other wirelessly (or by wireline). In one embodiment, the vending machines 605, 610 and 615 are located adjacent each other and one of the machines includes the interactive display 125. For example, vending machine 605 includes the interactive display 125 and a coin/currency acceptor and/or dispenser mechanisms. A customer may select a product located in the vending machine 610 by touching a point or area on the interactive display 125 (on machine 605) that is associated with the displayed image representing a product located within the machine 610. In response machine 605 transmits a wireless message to the machine 610 causing the machine 610 to dispense the selected product. As will be appreciated, one or more of the machines 605, 610 and 615 may have a product delivery sensing system, and where the machine 610 has a product delivery sensing system, the machine 610 may transmit a wireless message to the machine 605 indicating whether or not the selected product was successfully vended. If not, the machine 605 may offer the opportunity to select another product or return the customer's money. It will be understood the communication between machines 605, 610, 615 may be through a wirelink, or combination of wireless and wirelink.

The vending machines 605, 610 and 615 may exchange setup information via messages (wireless or wireline). Such setup information may include numbers of shelves, numbers of product queues on each shelf, numbers of products in each queue, product price for each product queue, or other information. In an embodiment where only one machine has a user interface, such setup information may enable that machine to provide, in the interactive display 125, menu and selection choices for products in the other machines.

In some embodiments, one of the vending machines controls displays on one or more of the other vending machines. For example, the computer subsystem 170 in vending machine 605 can control the displays 125 on vending machines 610 and 615. Therefore, the computer subsystem 170 in vending machine 605 can coordinate the displays 125 on vending machines 610 and 615. Additionally, the computer subsystem 170 in vending machine 605 can couple the display 125 on vending machine 605 with the displays 125 on vending machines 610 and 615 to display unified media content such that the displays form a video wall. It will be appreciated that although three vending machines are shown, the video wall and coordinated displays can include any number of displays and vending machines.

The machines 605, 610 and 615 may exchange operational status information (wireless or wireline). Such operational status information may include current inventory in each product queue, cumulative count of number of activations of a product queue dispenser, time since last servicing call, required maintenance, detected electronic or mechanical failures, or other information. Additional description of various methods involving communications between vending machines 605, 610, 215 in a system such as the system 600, may be found in U.S. patent application Ser. No. 12/380,952, filed on Mar. 5, 2009; and may be found in U.S. patent application Ser. No. 12/380,924, filed on Mar. 5, 2009, which are incorporated herein by reference. Further, various additional methods described in U.S. Pat. No. 6,457,038 filed on Mar. 12, 1999; U.S. Pat. No. 6,925,335 filed on July 5, 2001; U.S. Pat. No. 7,010,594 filed on May 22, 2001: U.S. Pat. No. 7,013,337 filed on May 11, 2001; U.S. Pat. No. 7,020,680 filed on Aug. 6, 2001; U.S. Pat. No. 7,139,616 filed on May 2, 2005; U.S. Pat. No. 7,164,884 filed on Jun. 6, 2001; U.S. Pat. No. 7,167,892 filed on Nov. 26, 2003; U.S. Pat. No. 7,171,451 filed on Jul. 30, 2002; U.S. Pat. No. 7,181,501 filed on Oct. 4, 2001, which are incorporated herein by reference, may be integrated or utilized wholly or partially in the system 600 and its alternative embodiments.

Devices other than vending machines may additionally or alternatively communicate wirelessly with one or more of the vending machines 605, 610 and 615. For example, a portable computer or other hand-held device 620 communicates wirelessly with the machine 605. The portable device 620 can be a handheld device configured to be used by a technician to communicate setup information with the vending machines 605, 610 and/or 615 when installed, reconfigured or restocked, or to communicate operational status information. A technician in a service van 625 communicates wirelessly with the machine 605 from outside the building where the machine is located to determine whether service on one or more of the machines 605, 610 and 615 is required and, if so, what kind of service.

In one embodiment, the portable device 620 is configured to control operation of the interactive display 125 on the vending machine 605, and may transmit (download) media information or files to the vending machine 605. The portable device 620 may also receive media metrics, operational status information and setup information from the vending machine 605.

Where the facility in which the vending machines 605, 610 and 615 are located has a wireless access point 630, the machine 605 may communicate wirelessly through the access point 630 to a device 635 coupled to the access point 630 via a network 640 (e.g., Internet or another communication network). The device 635 may be a remotely located central server or other controller for an operator of a number of such vending machines. For example, the device 635 can be a regional office that operates a number of vending machines 100 within proximity to the device. Through the use of a device 635, the operator may achieve a benefit such as avoiding the cost of sending a technician to the location of the vending machines 605, 610 and 615 to obtain operational status information. Additionally, the operator can perform a mass or selective update of product pricing information, software updates, media information (such as, but not limited to, advertising information, promotional information, media control information, and audio and video content) or a combination of these, to the vending machines within the system 600.

In some embodiments, the device 635 is located at a remote operating center (discussed in further detail herein below) and one or more of the portable devices 620 operate as regional offices. For example, each portable device 620 (e.g., handheld device) is located at a specified location (such as, but not limited to, a shopping mall office). The portable device 620 communicates with vending machines 605, 610, 615 located within one-thousand feet (1000′). It will be understood that one-thousand feet merely is for example purposes and ranges that are higher or lower could be used without departing from the scope of this disclosure. The portable device 620 acts as a regional office while the device 635 operates from the remote operating center.

In some embodiments, the vending machine 605 is capable of cellular communication. In such embodiments, a personal digital assistant 645 (FDA) or other cellular-capable device may ‘call’ the machine 605 at its cellular phone number to establish wireless communication via a base station 650 in order to send setup information or receive operational status information. Similarly, the base station 650 may be coupled to the network 640, allowing the device 635 to communicate with the vending machine 605 via the base station 650.

The wireless communication between the vending machine 605 and any one or more of the portable device 620 the wireless access point 630, and the vehicle 625 may use the IEEE 802.11 standard (referred to as a “WiFi standard”), the IEEE 802.16 standard (referred to as a “WiMAX standard”), or any other suitable wireless communications interface standard. The machines 605, 610 and 615 may form a wireless ad hoc network or other mesh network. In other embodiments, communication between the vending machine 605 and the base station 650 may be conducted under a standard other than a cellular wireless standard.

While only the vending machine 605 is shown communicating wirelessly with the portable device 620 the wireless access point 630, and/or the vehicle 625, it will be understood that any or all of the machines 605, 610 and 615 may be configured and operate to engage in such communications. In embodiments where setup and/or operational status information are located in the vending machine 605, another vending machine, such as vending machine 615, may provide wireless communication to an external device, such as the portable device 620. In such an embodiment, status information is wirelessly communicated from the vending machine 605 to the vending machine 615 and then wirelessly communicated to the portable device 620. Similarly, setup commands and information are wirelessly communicated from the portable device 620 to the vending machine 615 and then wirelessly communicated to the vending machine 605.

In other embodiments, communications among the vending machines and/or between the vending machine 605 and the device 635 may be via wireline, or combination of wireline and wireless. Further, communications among the machines 605, 610 and 615 and/or to the portable device 620 may be through a limited range connection, such as BlueTooth®, and may utilize infrared or other wireless methods.

In some embodiments, the operator may purchase product inventory to stock in the vending machines. In other embodiments, an operator may purchase and install machines that a manufacturer or other entity uses for consignment sales. Where such consignment products have a high price, cash sales may be impractical and the vending machine may be equipped with a card reader to scan credit or debit cards, or an identification card (or other issued card), such as an employee identification card or student identification card in a closed cash system, to fund the transaction. In such embodiments, the vending machine utilizes wired or wireless communication to communicate with a transaction network, independent sales organization, acquiring bank, or other transaction authorizing entity to receive authorization for the transaction.

The vending machine 100 includes a connection to the internet or other data network via a hard-wire Ethernet connection, WiFi connection, or other wireless/cellular connection. The connection to the internet is used for collecting sales, machine health and other data. The Internet connection also provides for the vending machine to receive media metrics or files that include, but are not limited to, a selection of what advertisements, messages, or images are to be displayed, as well as the content thereof configured in any suitable file (see below). Additionally, the vending machine can feedback, via the internet connection, media metrics that include, but are not limited to, what advertisements have been displayed, operational status information, setup information and any other information capable of being collected or generated by the vending machine, including product inventory and money collected. Further, an operator can download media content, such as, but not limited to, messages, images, advertisements (relating to products available for vending from the vending machine 100, as well as other topics), specials, combination vending information, product nutritional information, environmental information (e.g., weather) and time dependent information (e.g., duration advertisements or weather announcements), to the vending machine 100.

In some embodiments, the computer subsystem 170 communicates via the internet or data network to send information to and receive this information from the operator/technician (e.g., via portable device 620, vehicle 625, device 635 or PDA 645), and further operates to collect the information for sending to the remote location. In other embodiments, the VMC 150 performs one or more of these functions. In yet another embodiment, the VMC 150 performs one or more of these functions under the control of the computer subsystem 170. In other embodiments, the VMC 150 collects the information related to vending information and forwards it to the computer subsystem 170 for transmission. This may be accomplished by the VMC 150 periodically sending such information to the computer subsystem 170 or upon the request (i.e., interrogation request) or command of the computer subsystem 170.

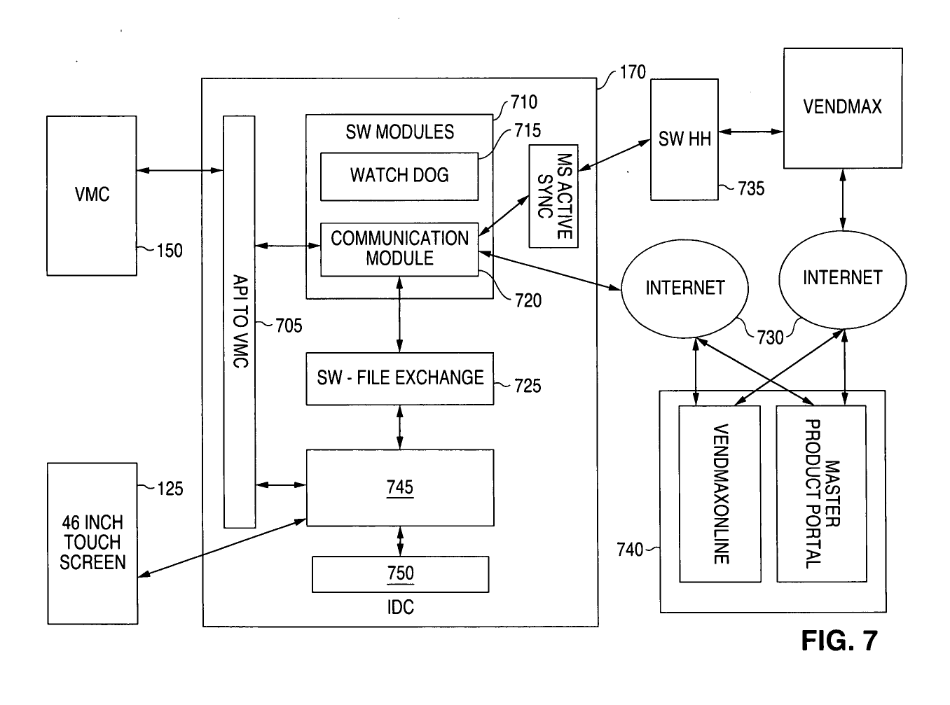

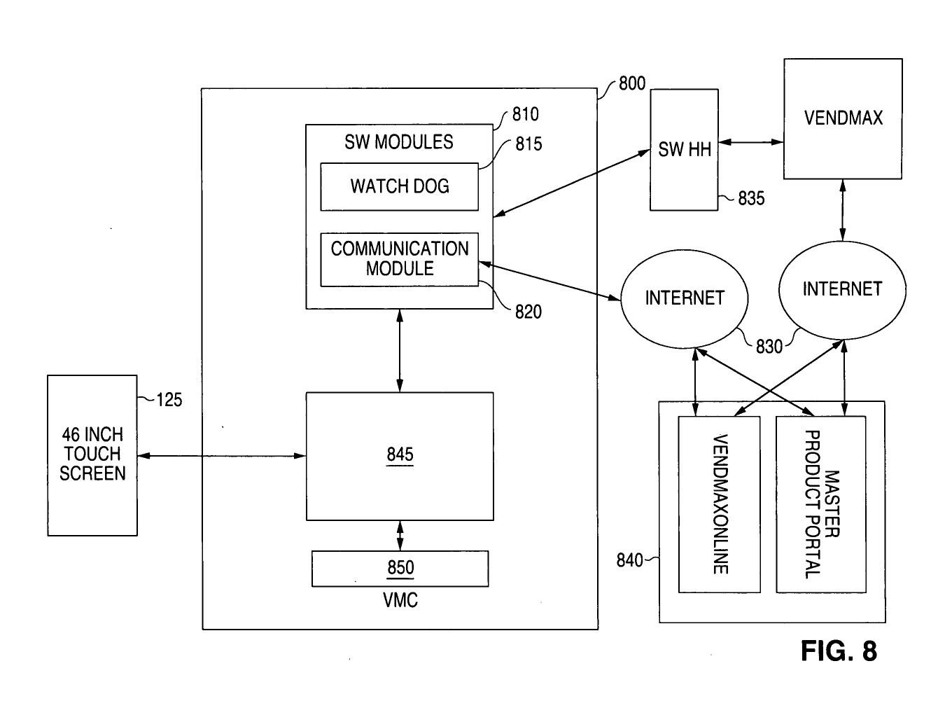

In one example, the computer subsystem 170 forwards the media information (such as media content) to the display controller 175. When received from the operator, the computer subsystem 170 stores the information in memory (discussed in further detail herein below with respect to FIGS. 7 and 8) and determines whether or not the information is related to (e.g., for use by, or display) the interactive display 125 or related to vending operations. If related to the interactive display 125, the computer subsystem 170 controls and forwards information to the display controller 175. The media content is then displayed on the interactive display. The touch-screen controller 180 also sends to the computer subsystem 170 (and then forwarded to the VMC 150 for further processing) user input information, including information relating to any product or service selections made by a customer.

When the computer subsystem 170 receives information from the VMC 150, the computer subsystem 170 determines whether the information is content to be displayed, display control content (e.g., information instructing the computer subsystem 170 how or when to display the content on the interactive display 125), or configuration content (e.g., operating parameters for the computer subsystem 170 and the display controller 175 such as, but not limited to, operating software upgrades). The computer subsystem 170 stores the information in memory. In some embodiments the memory is included within the computer subsystem 170. In additional and alternative embodiments, the memory is external to the computer subsystem 170. Thereafter, the computer subsystem 170 causes the interactive display 125 to display content based on the display content information.

The computer subsystem 170 can cause the interactive display 125 to run a full screen advertisement when not conducting a vend operation or during one or more predetermined time periods. Such an advertisement may relate to products available for vending from the vending machine 100 or to other topics. Additionally, the computer subsystem 170 can cause the interactive display 125 to display a banner during a vend operation and/or display a special promotion when a particular product is selected. The computer subsystem 170 can cause the interactive display 125 to provide a virtual display of products (for example, but not limited to, a graphical representation of products) contained in the vending machine 100. The virtual display may also be one or more representations of the available products on shelves that the user can select by touching a desired product. The display of products can match the internal configuration of the vending machine 100. Additionally, the virtual display can display products in a different order or in a manner to promote them (or otherwise emphasize them) in a way that is not linked to how products are actually stored inside the machine. For example, the virtual display can vary the size or location of one or more products that is being promoted. In an additional example, the virtual display can animate one or more of the products that is being promoted. Further, the computer subsystem 170 can cause the interactive display 125 to display the virtual display in response to a user touching the screen or providing a form of payment (discussed herein below). Upon user input, the virtual display may be enlarged or shrunk (such as when the customer selects a product, that image can be enlarged) and the user may be prompted to confirm his/her selection. The computer subsystem 170 can cause the interactive display 125 to display news and weather information and broadcasts. The computer subsystem 170 can cause the interactive display 125 to display advertisements, graphics, sounds or a combination of these to attract a customer to the vending machine 100.

FIG. 7 illustrates a block diagram of the computer subsystem 170 according to one or more embodiments of the present disclosure. The embodiment of the computer subsystem 170 shown in FIG. 7 is for illustration only and other embodiments could be used without departing from the scope of this disclosure.

The computer subsystem 170 is computer system configured to control the functions of the interactive display 125; communicate via the Internet and a handheld device 735; communicate with a vending management system; communicate with a reporting portal (e.g., web-based portal); and communicate with a master products portal at remote operating center 740. The computer subsystem 170 is coupled to the VMC 150 via a communications bus. The bus may be serial or parallel. An application programming interface (API) 705 (with a portion 705a resident in the computer subsystem and a portion 706a resident in the VMC 150) translates commands and data communicated between the two devices. In some embodiments, the API 705 is a windows Dynamic Link Language (DLL) that allows programs running within the computer subsystem 170 to control the vending machine through the VMC 150. In one embodiment, the computer subsystem 170 includes, and operates in accordance with, a high level operating system, such as Windows embedded XP. The computer subsystem 170 includes one or more Streamware (SW) modules 710. The SW modules 710 include a watchdog module 715 and a communication module 720. The watchdog module 715 monitors all vending machine functions, media and sales. The watchdog reports results of the monitored systems and events to the communication module 720. The communication module 720 is a medium-independent communications module that can transfer data through a handheld device 735, Internet 730 connection or cellular network. The communications module 720 determines the best and most economical way to send information based on the connection type and costs. The communications module 720 makes determinations based at least in part on the time value of the data sent both ways and the size of the data. The communications module 720 optimizes the total cost of the communications to and from the vending machine 100. The communication module 720 enables communication between a file exchange manager 725 and the APT 705.

In some embodiments, the communication module 720 also provides the computer subsystem 170 with a communication via the internet 730. In such embodiments, the computer subsystem 170 communicates via the internet to send information to and receive information from the operator/technician (e.g., via portable device 620, vehicle 625, device 635 or PDA 645). For example, the computer subsystem 170 can forward vending machine health and operational status information (such as, but not limited to, product inventory) from the VMC 150. When the computer subsystem 170 receives machine health and operational status information from the VMC 150 and forwards to the operator via a handheld computer 735, a vehicle connection (described in further detail herein above with respect to FIG. 6). Thereafter, the operator can forward the information to the remote operating center 740. Additionally, and alternatively, the computer subsystem 170 can forward the machine health and status information via the internet 730 to the remote operating center 740.

The file exchange manager 725 manages files exchanged between the VMC 150 and the computer subsystem 170. As such, the file exchange manager 725 manages the transfer of data between processes running on the computer subsystem 170 to the handheld 735 and remote operating center 740. Additionally, the file exchange manager 725 manages files exchanged between the remote operating center 740 and the computer subsystem 170.

The handheld device 735 is a mobile handheld computer or memory storage device (such as, but not limited to a non-volatile memory device). The handheld device 735 is carried by a technician. The handheld device 735 collects data from the vending machine 100 (e.g., via the computer subsystem 170). The handheld device 735 also sends data to the vending machine 100. The handheld device 735 can send and receive data to the vending machine 100 using a wireless or wireline connection. When using a wireless transfer medium, such as WiFi, the handheld device 735 can send and receive files to the vending machine 100 when the handheld device 735 is within a proximity of the vending machine 100. For example, the handheld device 735 can communicate with the vending machine 100 when the handheld device 100 is located within a one-thousand foot (1000′) radius of the vending machine 100. The handheld device 735 provides a mechanism for advertisers, via a technician, to upload new content and have the new content displayed in the interactive display 125 on the machine 100. The handheld device 735 provides a mechanism for suppliers, via a technician, to authorize their products to be vended in the vending machine 100.

The remote operating center 740 is a central or remote facility that provides reporting to the end consumer, vending operator, product suppliers, and any advertisers. The reporting includes data for the vending consumer, data for the vending operator or bottler, data for the product supplier that may sell products in the vending machine 100, data about advertising and metrics regarding what advertisements were displayed. The remote operating center 740 provides a mechanism for advertisers to upload new content and have the new content displayed in the interactive display 125 on the machine 100. The remote operating center 740 provides a mechanism for suppliers to authorize their products to be vended in the vending machine 100.

The computer subsystem 170 includes a central processing unit (CPU) 745 and a memory unit 750. The memory unit 750 may include different levels of cache memory, main memory, hard disks, Secure Digital (SD) cards (such as non-volatile removable flash drives) and remote storage locations. The memory unit 750 includes programming instructions adapted to be utilized by the CPU 745 to direct the interactive display 125 and speakers 130, manage local and remote communications with operating personnel. The CPU 745 and memory unit 750 further are adapted to store inputs received from the interactive display 125 for illustrations, such as, but not limited to a product selected via the interactive display 125.

In some embodiments, the computer subsystem 170 is capable of receiving and processing streaming media information. In such embodiments, the computer subsystem 170 controls the interactive display 125 to display the streaming media information at substantially the same time as it is received by the vending machine 100 or the interactive display 125 can display the streaming media information at a time subsequent to when the streaming media information is received by the vending machine 100.

FIG. 8 illustrates a block diagram of an alternative embodiment of a VMC 800 in which the functions and operations of the computer subsystem 170 and VMC 150 are integrated together into the VMC 800 according to embodiments of the present disclosure. This embodiment of the combination VMC 800 shown in FIG. 8 is for illustration only and other embodiments could be used without departing from the scope of this disclosure.

The VMC 800 is computer system configured to perform the functions of the VMC 150 and the computer subsystem 170. The VMC 800 is coupled to the vending components of the vending machine (not shown) such as, but not limited, the dispensing motors, monetary input elements (such as, but not limited to, bill validator, coin acceptor, credit card validator, card reader) and change return mechanism. The VMC 800 includes a number of Streamware (SW) modules 810. The SW modules 810 include a watchdog module 815 and a communication module 820. The watchdog module 815 monitors all vending machine functions, media and sales. The watchdog reports results of the monitored systems and events to the communication module 820. The communication module 820 is a medium independent communications module that can transfer data through a handheld device 835, Internet 830 connection or cellular network. The communications module 820 determines the best and most economical way to send information based on the connection type and costs. The communications module 820 makes determinations based at least in part on the time value of the data sent both ways and the size of the data. The communications module 820 optimizes the total cost of the communications to and from the vending machine 100.

The communication module 820 provides the VMC 800 with a communication via the internet 830. In such embodiments, the VMC 800 communicates via the internet 830 to send information to and receive information from the operator/technician (e.g., via portable device 620, vehicle 625, device 635 or PDA 645). For example, the VMC 800 can send vending machine health information, operational status information (such as, but not limited to, product inventory) and media metrics to the operator via a handheld computer 735 (e.g., via portable device 620 or FDA 645) or a vehicle connection (described in further detail herein above with respect to FIG. 6). Thereafter, the operator can forward the information to the remote operating center 840. Additionally, and alternatively, the VMC 800 can forward the machine health and operational status information via the internet 830 to the remote operating center 840.

The VMC 800 includes a CPU 845 and memory unit 850. The memory unit 850 may include different levels of cache memory, main memory, hard disks, and remote storage locations. The memory unit 850 includes programming instructions adapted to be utilized by the CPU 845 to direct components of the vending machine 100 through vending operations, direct the interactive display 125 and speakers 130, and manage local and remote communications with operating personnel. CPU 845 and memory unit 850 further are adapted to store inputs received from the interactive display 125 for illustrations, such as, but not limited to a product selected via the interactive display 125.

In some embodiments, the VMC 800 is capable of receiving and processing streaming media information. In such embodiments, the VMC 800 controls the interactive display 125 to display the streaming media information at substantially the same time as it is received by the vending machine 100 or the interactive display 125 can display the streaming media information at a time subsequent to when the streaming media information is received by the vending machine 100.

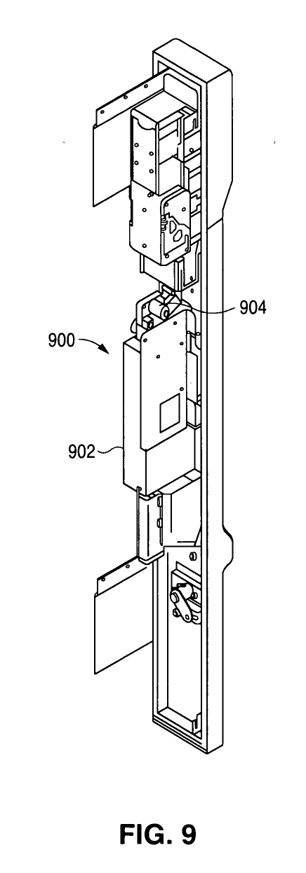

FIG. 9 illustrates a simplified electronic vending machine coin handling system 900 according to one embodiment of the present disclosure. The embodiment of the coin handling system 900 shown in FIG. 9 is for illustration only. Other embodiments of the coin handling system 900 could be used without departing from the scope of this disclosure.

The coin handling system 900 is disposed within the monetary door 120. In one embodiment, the coin handling system 900 is accessible for maintenance by sliding the monetary slide 500 forward via rails attached to the cabinet 105.

The coin handling system 900 includes a coin receiving and dispensing mechanism 902 as is known in the art. A coin return actuator of the coin receiving and dispensing mechanism 902 is coupled to a coin return motor 904. The coin return motor 904 also is coupled to the VMC 150. The coin return motor 904 may be an electronically controlled actuator.

When a customer touches a coin return icon on the interactive display 125, the VMC 150, 800 sends a signal to activate the coin return motor 904. Activation of the coin return motor 904 rotates a cam, which presses the coin return actuator of the coin mechanism 902 causing any coins contained within a receiving tray of the coin receiving and dispensing mechanism 902 to be released via a path coupled to the coin return tray.

The vending machine 100 is capable of receiving multiple forms of payment from a customer. For example, when purchasing a product or service, the customer can insert paper currency into a bill validator/dispenser, insert coin currency into a coin acceptor/dispenser, insert a credit card into a credit card validator (or slide the magnetic strip of the credit card across a magnetic strip reader), hold a service card proximate to a card reader, enter a customer identification number, and/or provide identification via a biometric sensor such as a fingerprint scanner, palm scanner, and/or a retinal scanner.

The service card can be an identification (ID) card issued by the customer school or issued by another business associated with the vending machine 100. Either one or both of the service card and customer identification number can be associated with a financial account at a transaction authorizing entity.

The financial account can be held at a bank or other transaction authorizing entity wherein, upon reading the service card or upon the customer entering the customer identification number, or both, the vending machine 100 accesses the account via the internet, or other communication connection, to withdraw funds corresponding to an amount of a product or service selected by the customer (a payment amount) or otherwise receive authorization for the transaction. In some embodiments, a password or personal identification number must be entered as well.

Additionally and alternatively, the financial account may be held with a school, business or other transaction authorizing entity associated with the vending machine 100 such that, upon reading the service card or upon the customer entering the customer identification number, or both, the vending machine 100 accesses the school or business via the internet, or other communication connection, to withdraw funds or submit a bill for future payment corresponding to the payment amount of a product or service selected by the customer, or otherwise receive authorization for the transaction. In such example, the school or business may later send the customer a bill for items purchased via one or more vending machines 100 during a specified duration of time.

The vending machine 100 can be configured to accept and dispense multiple types of currency (e.g., currency from different countries). For example, the vending machine 100 may be located in an area where multiple types of currency are used, such as near a border between two countries. In such an example, the VMC 150, 800 receives currency exchange rate data via the internet connection or other communication link. When the customer inserts currency that is of a different type than the type in which process are displayed by the vending machine 100 (for example, but not limited to, if a pound (£) note or coin is inserted in a machine displaying its prices in dollars ($)), the VMC 150, 800 computes the price for the selected product based on the current exchange rate. In some embodiments, the VMC 150, 800 instructs the computer subsystem 170 to display the price in pounds if a pound note or coin is inserted. In some embodiments, the vending machine 100 displays the price of each product in the vending machine in two or more different currency types.

The vending machine 100 is capable of vending multiple products and services. The vending machine 100 can provide icons on the interactive display 125 to enable a customer to execute one or more of these functions.

For example, the vending machine 100 can perform a cash recycling service. A customer initiates a cash recycling transaction by touching the cash recycling icon in the interactive display 125. It should be noted that the cash recycling icon may actually be an icon associated with cash recycling but not stating cash recycling. For example, the interactive display 125 may display a deposit icon or an icon with a dollar sign ($). The vending machine 100 provides a list of financial institutions or other payment recipients on the interactive display 125. The customer selects the financial institution where the account to which the customer wishes to make a deposit is located. Then, the vending machine 100 prompts the customer to enter the account number. The vending machine 100 provides a keypad on the interactive display 125 to allow the customer to enter the account number. The customer enters the account number and then deposits currency into the bill validator, the coin acceptor or both. The vending machine 100 counts the amount of currency inserted by the customer (a payment amount) and communicates with the selected bank to credit the inserted amount to the customers account. Thereafter, the vending machine 100 uses the inserted currency in future transactions either as change for vending operations for cash withdrawal requests made by a customer.

Additionally, the customer can select a cash recycling transaction by inserting a deposit slip into the bill validator or another insertion device. In such example, the computer subsystem 170 or VMC 800 recognizes that the deposit slip was entered instead of paper currency. Then, the vending machine 100 reads the bank routing number and account number from the deposit slip and prompts the customer to insert the desired currency. In some embodiments, the vending machine 100 also provides a keypad on the interactive display 125 to allow the customer to enter how much she intends to insert (e.g., deposit). The customer inserts the currency into the vending machine 100. As before, the vending machine 100 counts the amount of currency inserted by the customer (the payment amount) and communicates with the selected bank or other payment recipient to credit the inserted amount to the customer's account. Thereafter, the vending machine 100 uses the inserted currency in future transactions either as change for vending operations for cash withdrawal requests made by a customer.

Further, the customer can select a cash recycling transaction by inserting (e.g., swiping) a debit card issued by their bank or other payment recipient. The vending machine 100 provides the customer with a number of icons for possible transactions since, for example, the customer may be inserting the debit card prior to purchase of a product or service. The customer then selects the cash recycling icon to initiate the cash recycling transaction. In response, the vending machine 100 determines the appropriate bank routing number and account number corresponding to the debit card. Then, the customer inserts the currency in the manner described herein above.

In an additional example, a local business can deposit funds, such as a daily receipts, into the business account. A representative of the business selects the cash recycling icon. In some embodiments, the vending machine 100 prompts the representative to select a financial institution (or other payment recipient) and account number as described herein above. In additional and alternative embodiments, the representative can insert a deposit slip as described herein above. In yet additional and alternative embodiments, the representative merely enters a business identification number or selects an icon associated with the business. For example, the business may have established a customer account (discussed herein below) such that an icon is provided on the interactive display 125 or the vending machine 100 can determine a bank routing number and account number by accessing the customer account. Thereafter, the representative inserts the deposit into the vending machine via the bill validator, the coin insert, or both. In some embodiments, the representative also enters, via a keypad on the interactive display 125, the amount being deposited (the payment amount). Then, the vending machine 100 contacts the financial institution associated with the business (e.g., using the routing number and account number entered or in the customer account) and credits the deposited funds to the business account.

In some embodiments, the vending machine 100 can perform a currency exchange service. The vending machine 100 stores one or more different currency types. The vending machine 100 receives exchange rate data via the Internet or other communication link. When a customer wishes to exchange one currency type for another, the interactive display 125 prompts the available options for exchange. The customer can select what currency type she has and what currency type she desires to receive. The customer also enters, via the interactive display 125, the amount of currency that she wishes to exchange. The vending machine 100 determines the appropriate exchange rate and computes the amount that will be due to the customer less a conversion fee charged by the vending machine. The conversion fee can be a fixed rate, a staged or stepped rate, a percentage of the transaction amount, or a combination of these. The interactive display 125 displays the amount that the customer will receive if she proceeds with the transaction. The interactive display 125 also can include a confirm icon to allow the customer to accept the transaction and/or a cancel icon to allow the customer to deny the transaction. In some embodiments, the customer confirms the transaction by inserting the currency for exchange. In some embodiments, the vending machine 100 cancels the transaction if no currency is inserted after a specified period of time. After the customer inserts the currency, the vending machine 100 outputs the desired currency type. The desired currency is output by the bill validator, a coin return tray, or both.

In each of the cash recycling embodiments, the operator and the banks transfer funds between each other using financial transfer mechanisms as is known in the art or hereinafter discovered. Accordingly, various methods used by the operator to transfer funds to the financial institution associated with the credit of a deposit do not limit the scope of this disclosure.

In some embodiments, the vending machine 100 enables a customer to pay a bill to a financial institution, or other payment recipient. For example, the customer can insert their credit card into the credit card validator. The vending machine 100 provides the customer with a number of icons for possible transactions since, for example, the customer may be inserting the credit card prior to purchase of a product or service. The customer selects the bill-payment icon to execute the bill-payment process. The customer enters the amount that she wishes to pay (a payment amount) via a keypad on the interactive display 125. The customer can insert currency into the vending machine 100 or select that funds be transferred from the customer account.

In some embodiments, the vending machine 100 enables a customer to pay a bill to a public utility, bank or other payment recipient. For example, the customer selects the bill-payment icon to execute the bill-payment process. Thereafter, the customer can select a public utility or bank from a group of icons on the interactive display 125. The customer can select the public utility to pay for services such as gas, electric, water, telephone, cable TV or satellite TV. The customer can select the bank to pay for mortgages, car loans or other loans. The customer enters the amount that she wishes to pay (a payment amount) via a keypad on the interactive display 125. The customer can insert currency into the vending machine 100 or select that funds be transferred from the customer account.

The vending machine is capable of providing multi-vend promotions. In a multi-vend promotion, the vending machine 100 offers the customer a discount on a product when the customer selects an associated product. For example, when the customer selects a soda beverage, the vending machine 100 offers the customer a discount on a second unit of the same soda beverage. Additionally, the vending machine 100 can offer a discount on a different beverage if purchased with the selected soda beverage. The vending machine 100 provides the offer for a multi-vend operation by displaying the images corresponding to the selected product and the associated product, or products, on the interactive display 125. The vending machine 100 can provide an animated display to draw the customer's attention to the multi-vend offer. In some embodiments, the vending machine 100 offers the multi-vend prior to the customer's first selection. In such embodiments, the vending machine 100 can display, prior to a first product selection, associated products eligible for promotion pricing in the multi-vend. In some embodiments, the vending machine 100 presents, via display 125, a shopping cart to the customer to purchase one or more products at checkout. Additional description of methods regarding multi-vend or sales discounts may be found in U.S. application Ser. Nos. 12/380,952 and 12/380,924 previously identified herein and incorporated herein by reference.

In some embodiments, the vending machine 100 can print coupons for later redemption. The vending machine 100 provides an advertisement via the interactive display 125 that informs the customer that a coupon may be printed by the vending machine 100. The vending machine 100 can provide this coupon offer before, during or after a vending transaction. The coupon can be redeemed by the customer in the vending machine 100 or in another vending machine (e.g., vending machine 610 or 615 illustrated in FIG. 6) in the vending machine network. Additionally, the coupon can be redeemable at the business of an associated or nearby merchant. In yet an additional embodiment, the coupon is redeemable during an internet transaction.

In additional and alternative embodiments, the vending machine 100 transmits the coupon to the consumer and displayed on the consumer's cell phone, PDA or computer. The coupon transmitted to the customer's cell phone, PDA or computer can be scanned, or received, at the vending machine, or another vending machine, to be redeemed by the consumer. Therefore, the customer can receive and redeem the coupon without the need for the coupon to be printed on paper.

In some embodiments, the coupon is printed by a printer (not shown) in the vending machine 100. In additional embodiments, the coupon is credited to the customer's account, such as, but not limited to, a vending machine network account, student account, or business account. In some embodiments, the customer can select whether to have the coupon printed by the vending machine 100, receive the coupon via a cell phone, PDA, or other computer, or applied to a customer's account.

When credited to the customer's account, the customer can, at a later time, print or obtain the coupon from the account. For example, the customer can access their account via the Internet and print it there from. In an additional example, the coupon is made available when the customer uses the vending machine 100 again or when the customer uses another vending machine within the vending machine network. In such example, the vending machine 100 used in the subsequent transaction can inform the customer that the coupon is available to be applied to a purchase. The vending machine 100 can display an image of the coupon on the interactive display 125. Then, to apply the coupon to the purchase, the customer merely touches the image of the coupon on the interactive display 125.

When the coupon is redeemable at an associated merchant, the coupon can be temporal, regional or both. For example, a merchant located in a shopping area where the vending machine 100 also is located may desire to provide a coupon for a particular product that the merchant sells. The merchant may be trying to eliminate excess inventory, sell remaining inventory of an obsolete or retired product model, promote the sale of a new product model, or any other promotional reason. Therefore, the merchant contracts with the vending machine operator to provide a coupon in the vending machine 100. The merchant may provide a copy of the proposed coupon to the operator. Additionally and alternatively, the merchant may just provide the information about the promotion (e.g., price or discount) and the operator designs the coupon. The operator sends media information to the vending machine 100. The media information can include the graphics for the coupon, the parameters by which the vending machine 100 is to offer the coupon, the means by which the vending machine 100 can provide the coupon to the customer (e.g., printing the coupon or applying to the customer's account), time periods to display the coupon (e.g., media metrics), a number of coupons to offer, and duration to offer the coupon (e.g., how long to offer the coupon such as offer until Friday the 30^{th}).

The coupon may be linked to particular product in the vending machine 100 such that the purchase of the product prompts the offer of the coupon to the customer. Alternatively, the coupon may be offered to every customer that approaches the vending machine 100. Further, the coupon may be offered as a prize in a game offered via the interactive display 125 after or during a vend operation.

Further, vending machine 100 can inform the customer where the coupon can be redeemed. The interactive display 125 can display an address or graphic location of the business where the coupon can be redeemed. The interactive display 125 also can display a list of printable directions to assist the customer to get to the location of the business.

In yet additional and alternative embodiments, the vending machine 100 can offer multiple different coupons. For example, the vending machine 100 can provide images on the interactive display 125 associated to a number of different coupons. These coupons may be from the same vendor, merchant or business or from different vendors, merchants or businesses. The coupons may be offered in any of the manners described herein above. The customer selects a desired coupon, or coupons, by touching the image, or images, of the coupon on the interactive display 125. Thereafter, the vending machine 100 issues the coupon to the customer using any of the methods described herein above. Additionally, the vending machine 100 can record and store what coupon, or coupons, was issued. Therefore, the vending machine 100 can include, in a media metrics message, what coupons, and how many of each, have been issued.

The vending machine 100 can access a customer account via the Internet or other communication link. The customer account may be managed by a customer account manager, such as, but not limited to the operator of the vending machine, a business in association with the operator, an educational institution (e.g., school), government entity (e.g., a library or parks and recreation department) or another third party (e.g., such as, but not limited to, a financial institution, merchant, or department store that maintains customer accounts).

The customer may register with a business associated with the operator. Although the following is illustrated with respect to the business managing the customer account, the process applies equally to an operator, educational institution, a government entity, a third party, or other account manager managing the account. The customer enters personal profile information. The personal profile information includes financial information such as, but not limited to, one or more bank routing numbers, one or more bank account numbers, one or more credit card numbers, a cellular (e.g., mobile) telephone number, and a billing address. The customer also may be prompted to enter other personal information, such as demographic information. In response to the customer completing the personal profile, the business issues the customer a customer identification number. In some embodiments, the business issues the customer a service card (e.g., an ID card). In yet additional and alternative embodiments, the business records a voice identifier of the customer, a fingerprint of the customer, a palm print of the customer, a retinal print of the customer and the like. In embodiments where one of a voice identifier of the customer, a fingerprint of the customer, a palm print of the customer and the like are used, the vending machine 100 includes appropriate sensors and/or microphones either on interactive display 125 or monetary door 120 to read or detect the input from the customer. In some embodiments, the business can record a password or a personal identification number (PIN), or both, to be used with any of the above when accessing the customer account.

The customer accounts can be used by the business to facilitate network promotions offering loyalty at other connected vending machines in a vending machine network managed by the operator. The business (or operator, educational institution, government entity, or third party) can offer promotions for the continued access of the vending machines in the vending machine network. For example, the business can offer a reduced price on one or more products in one or more of the vending machines 100 in the vending machine network. The reduced price can be offered for a duration of time, e.g., for one week after the initial purchase at a first vending machine 100. The reduced price can be offered after the customer has made a number of purchases in one or more of the vending machines 100 during a specified duration of time, e.g., five purchases in one month. The reduced price can be offered after the initial purchase at a first vending machine 100 and reduced further after every subsequent purchase. For example, the customer may pay full price for a product in the initial transaction. During a second transaction at any of the vending machines in the vending machine network, the customer may be given a one percent (1%) discount. During a third transaction at any of the vending machines in the vending machine network, the customer may be given a two percent (2%) discount. In some embodiments, the customer can receive discounts for one or more products in different vending machines when purchased in combination.

In some embodiments, the customer can access products or services from the vending machine 100 by using the customer's cellular (e.g., mobile) phone. It will be understood that use of a cellular phone is for example purposes only and many other portable communication devices could be used without departing from the scope of this disclosure. The vending machine 100 can display a telephone number on the interactive display 125. Additionally, the vending machine 100 can display different telephone numbers or extension numbers associated to different products in the vending machine 100. The customer 100 can dial a sequence (e.g., call) associated with a desired product. Additionally and alternatively, the customer can send a text message to the vending machine 100 using the sequence associated with the desired product. In response, the vending machine 100 uses the customer's cellular number received with the text or call to access the customer's account. The vending machine 100 debits the customer's account for the amount associated with the selected product and dispenses the desired product as appropriate.

In some embodiments, the customer or other user can interface with, or contact, the vending machine 100 via a Bluetooth® connection. In such embodiments, the customer can use their cellular telephone to detect the vending machine 100. The customer can transmit vending requests by sending the sequence associated with the desired product or service to the vending machine. The customer also sends a customer identification number (and password if required) to enable the vending machine to access the customer account.

In some embodiments, the vending machine 100 offers a game during or after a vend process. The vending machine 100 provides the game via the interactive display 125. The vending machine 100 can offer different games at different times of the day or in response to different products selected. In response to completing, or winning, the game, the vending machine 100 offers the customer a prize. The prize can be a coupon, as described herein above, another product, or a discount on another product.

The vending machine 100 is configured to display advertising, messages, promotions, etc. for merchants located in proximity to the vending machine 100. A server or advertising clearinghouse, such as the server 635, may be configured with various merchant media and transmit the media to the vending machine 100 via the internet, via a wireline communication, a wireless communication, a connection to a handheld device, or a combination of one or more of these. In some embodiments, the vending machine 100 receives streaming media information. Additionally, the media information can be received via the handheld device 620. A technician within proximity of the vending machine 100 can transfer media information to the vending machine 100 for later display.

The media information includes media content information and media control information. The media content information includes the images, sounds, video clips, and the like that is to be displayed by the interactive display 125 and broadcast by the speakers 130. The media control information includes configuration information directs how and when the media content information is to be displayed. For example, the media control information can include information that directs the vending machine 100 to display specified media content in response to certain products selected by the customer. Additionally, the media control information can include information that directs the vending machine 100 to display media content based on the customer profile in the customer account. In yet an additional example, the media control information can include information that directs the vending machine 100 to display specified media content in response to the customer's method of payment or an overpayment by the customer. In still yet an additional example, the media control information can include information that directs the vending machine 100 to display specified media content a certain number of times per day, for a certain duration, at a specified time each day, or any combination of the above. The media control information can also include information the directs the vending machine 100 to display media content within a specified portion of the interactive display 125, moving within the display, in another animated fashion, and/or within a banner.

The media information also can include vending related information. The media information can be downloaded and stored. Additionally, the media information can be streamed real-time. Further, firmware and software upgrades and maybe preloaded and controlled with downloads or real-time control. The media information can be multicast globally, regionally, locally, or to individual vending machines. The media information can be downloaded from a remote location 635, 740 or 840, service van 625, or handheld 620, 735, 835 or from other mobile memory means (such as, but not limited to, a media card, universal serial bus non-volatile memory, and SD-card).

The media information can include promotional advertisements or items associated with the merchants located in proximity to the vending machine 100. For example, the vending machine 100 located near the entrance to a movie theatre can vend movie tickets. Additionally, the vending machine 100 can vend coupons for products to be purchased at a concession stand in the movie theatre. Further, the vending machine 100 can vend a coupon to discount a product in the concession stand when a ticket is purchased. Additionally and alternatively, the vending machine 100 can vend a coupon to discount the movie ticket when a snack or beverage is vended.

Additionally, the media information can include movie trailers. The interactive display 125 can broadcast one or more movie trailers before, during or after a vend process has occurred. In such example, the interactive display 125 can be responsive to a touch by the customer to stop the movie trailer, move to the next movie trailer, restart the movie trailer, or purchase a ticket to see the movie associated with the movie trailer.

In an additional and alternative example, the vending machine 100 is capable of taking online orders for products sold by nearby merchants. For example, the vending machine 100 may be located in a shopping mall. When a customer visits a particular sporting goods store, the customer is informed by the sporting goods store sales attendant that the item that the customer desires to purchase currently is sold out or is available online only. The sales attendant can send the customer to the vending machine 100 to check to see if another sporting goods store location has the desired item or if the desired item is available for online purchase. The customer selects an icon on the interactive display 125 associated with the sporting goods store. In response, the interactive display 125 can display additional icons to assist the customer in finding and selecting the desired item or the interactive display 125 can provide the customer the ability to enter a number associated with the product (such as a brand and model or a Universal Product Code (UPC)). Thereafter, the vending machine 100 communicates with a database associated with the sporting goods store. The data base may be accessible via the internet or the data base information may have been transferred to the vending machine at a prior time as part of the media information. The vending machine 100 displays a location of the nearest sporting good store location that currently shows to have the desired option. Additionally, the vending machine 100 can display an option to purchase the item for pickup at the store or delivery from the store. If the customer selects an option to picking up at the store, the vending machine 100 can print a claim check to allow the customer to claim the item at the selected store location. If online purchase is available, the customer can select the item for purchase. In both cases, the customer can select a customer account for purchase, insert cash or insert a credit card. Thereafter, the vending machine 100 can offer the customer a discount to purchase a product in the vending machine 100.

The vending machine 100 is configured to accept a student identification (student ID) as a method of payment. When a student presents the student ID as a method of payment, the vending machine 100 accesses a student account. The student account can be stored at a financial institution (e.g., a student account) or the student account can be stored at the educational institution. The student account may include “parental options” that prohibit the purchase of certain items. The vending machine 100 debits the student account an amount for purchasing a product selected by the student from the vending machine 100.

In additional and alternative embodiments, the student can obtain other services from the vending machine. For example, the student can insert (or bring in proximity to a card reader) the student ID in order to make a tuition payment to the educational institution. Additionally, the student can insert (or bring in proximity to a card reader) the student ID in order to make a deposit into the student account. Further, the student can insert (or bring in proximity to a card reader) the student ID in order to obtain the student's grades such as, for example, obtaining the current grades, after an exam grade is posted, after semester grades are posted, and after a major paper/project's grades are posted. In yet an additional example, the student can insert (or bring in proximity to a card reader) the student ID in order to pay a fine, such as a parking ticket, that the student given by the educational institution's officials.

In some embodiments, the vending machine 100 provides news and weather alerts and announcements. The media information can include temporal information such as news and weather related information. The interactive display 125 can display news and/or weather information at specified times, periodically, prior to a vending transaction, during a vending transaction, after a vending transaction, in response to a customer request, or any combination of the above. The interactive display 125 also can display news and weather alerts. For example, the interactive display 125 can display weather information when weather is getting, or has become, dangerous. Additionally, the vending machine 100 can be responsive to Emergency Broadcast System (EBS) alerts to inform any individuals in proximity about severe or dangerous weather.

In some embodiments the vending machine 100 is configured to display product related information prior to a vending operation. The interactive display 125 displays a number of icons, each icon associated with a product in the vending machine 100. The icons may be simple graphics or images designed to resemble the look and size of the actual product. The customer can select an icon to request more information about that product. The customer can use the interactive display 125 to rotate the image of the product to obtain a 360° view of the product. The interactive display 125 can also display the nutritional data (e.g. a nutrition facts label). Also, the customer can select an option on the interactive display 125 to display a list of ingredients in the product.

In some embodiments, the vending machine 100 is configured to alert the purchaser that a product selected contains an ingredient to which the customer may be allergic. For example, when the customer sets up the customer account, the customer can include allergies to products in the personal profile. Thereafter, as the vending machine 100 receives the nutritional information for products, the vending machine 100 stores the list of ingredients for each product. When a customer selects a product and presents a customer identification number (or any other method to direct the vending machine 100 to access the customer account for payment), the vending machine 100 accesses the list of allergies in the personal profile and compares the list with the list of ingredients of the product selected by the customer. If there are one or more products on the list of ingredients that correspond with the product to which the customer indicated an allergic reaction in the personal profile, the interactive display 125 generates and displays a warning to the customer. The warning can include, but is not limited to, a display of the ingredients in the product to which the customer has indicated an allergy.

In some embodiments, the vending machine 100 restricts the products dispensed based on the products to which an allergic reaction is indicated in the customer profile. For example, a student account can include a list of allergies to products and/or ingredients. Additionally and alternatively, the student's parents and control the student's profile, and corresponding list of allergies to respective products, via a web-site.

In some embodiments, the vending machine 100 can provide transactions in multiple languages. The interactive display 125 can include an option to provide written displays in more than one language. Additionally and alternatively, the vending machine 100 can include an option to provide an audible message via speakers 130 in a different language than is displayed on the interactive display 125. The interactive display 125 provides an icon indicating that one or more alternative languages are available. If the customer desires another language, the customer selects the icon. The interactive display 125 displays a list of languages available. The customer selects a language from the list. Thereafter, the interactive display 125 displays text in the selected language, the speakers 130 announce selections in the selected language, or a combination of the two is performed by the vending machine 100.

The vending machine 100 is configured to inform the customer about the status of the vend process. For example, in response to the customer selecting an icon associated to the product or service, the interactive display 125 can display a graphic, such as, but not limited to, an animated image, directing the customer towards the next action. The customer can be directed to an input device such as the bill validator, coin acceptor, card reader, or other scanner to receive payment or access the customer account.

Additionally, the interactive display 125 can display an amount of money that has been detected by the vending machine 100 as being inserted. Additionally, the speakers 130 can broadcast an audible announcement indicating an amount of money that has been detected by the vending machine 100 as being inserted by the customer.

Thereafter, the customer can be guided by one or more images on the interactive display 125 to select a product or service, enter information, or other input as required by the transaction. In some embodiments, the display can highlight certain product or service icons when an appropriate amount of money sufficient to pay for the highlighted product or service is inserted into the vending machine. Once the icon is highlighted, the icon also is made receptive to a touch by the customer to select the product or service associated with the icon. For example, if the customer enters $1.00, the interactive display 125 highlights icons associated with products having a price less than or equal to $1.00. Therefore, the customer is able to select the highlighted icons to make a purchase.

In additional and alternative embodiments, if the customer attempts to select an icon associated with a product having a price in excess of the amount entered (e.g., price above $1.00 in the previous example), the vending machine 100 informs the customer that more money is required for the purchase. The interactive display 125 displays an additional amount required to purchase the desired selection. Additionally, the speakers 130 can broadcast a message indicating that more money is required or a message stating how much more money is required.

The interactive display 125 can also direct the customer's attention, via graphic images and sounds from the speakers 130, towards a return tray or trays if the money is being returned to the customer. For example, if the customer selects a product having a price less than the amount inserted by the customer (e.g., product price is 7 ¢ and amount inserted is $1.00), the interactive display 125 directs the customer's attention to the coin return tray prior to, during and immediately after the change has been deposited into the coin return tray. The interactive display 125 can generate a flashing arrow graphic, or an arrow moving from the center of the interactive display towards the coin return tray, or an image of the vending machine with a coin return tray location highlighted. Additionally, if the change due the customer exceeds $1.00, the vending machine 100 can refund the amount due in paper currency via the bill validator. In such example, the interactive display 125 can direct the customer's attention towards the bill validator prior to, during and immediately after the paper currency has been output from the bill validator.

In some embodiments, the vending machine 100 is configured to display products based on the current inventory. The vending machine 100 can receive inventory information from the operator. For example, after stocking/restocking the vending machine 100, the technician, using the handheld device, can inform the VMC 150, 800 regarding each product placed in the product storage area and the respective quantity for each product in the product storage area. Thereafter, the VMC 150, 800 debits the inventory quantities according to vending operations performed. When the VMC 150, 800 determines that a product is out of stock, the VME 150 (via the computer subsystem 170), 800 can remove the out of stock product from the interactive display 125. Additionally, the VMC 150, 800 can inform the operator regarding the out of stock status of the product via a wireless or wireline connection to the operator. Additionally, and alternatively, the vending machine 100 can include an RFID sensor configured to detect the status and quantity of each product in the product storage area.

In some embodiments, the vending machine 100 is configured to confirm a product selection prior to the vending of the product. After a customer has selected one or more products by touching the respective icons on the interactive display 125, the vending machine 100 stores a product identifier corresponding to the product in a memory (e.g., memory 254 in the VMC 125, memory 750 in the computer subsystem 170, memory 850 in the VMC 800, or another memory in the vending machine 100 not specifically illustrated). The interactive display 125 can display a request for the customer to confirm the selection. The interactive display 125 can display a ‘confirm’ icon and broadcast an audible message via speakers 130 informing the customer to confirm the selection. Additionally and alternatively, the interactive display 125 can highlight or animate the product icon to allow the customer to confirm the selection. Further, the interactive display 125 can display the product and suggest a response. For example, the interactive display 125 can display “you chose Oreos—is this the product you want?” The interactive display 125 and speakers 130 can inform the customer that the selection can be cancelled by making another product selection or touching a ‘cancel’ icon. After a customer confirms the product selection, the vending machine 100 cycles a dispensing mechanism corresponding to the product in order to release the selected product. As the product is released from a product storage tray, the product is deposited into a delivery bucket 300. The product within the delivery bucket 300 is accessible via the access door 310.

If the customer determines that the correct product was not selected, the customer may touch the cancel icon. The cancel icon appears on the interactive display 125 upon the touching of a product icon. Selection of the cancel icon removes the selection of the product identifier from a memory (discussed in more detail herein above) and from the interactive display 125. Additionally, selection of the cancel icon cancels the transaction such that no funds are charged to a credit card, debited to the customer account, or processed for billing through the customer's account.

Additionally, prior to confirming the selection by depressing the confirm icon, the customer may request that the vending machine 100 return the customer's money. The customer may request that the money inserted during the initiation of the transaction be returned by touching a coin return icon displayed in the interactive display 125.

The coin return icon is included within the interactive display 125 upon the insertion of money into any one or more of the bill validator, coin acceptor, and credit card validator. Selection of the coin return icon removes the entry of the product identifier from a memory, if entered (discussed in more detail herein above). Touching the coin return icon causes the vending machine 100 to return any money inserted into the coin insert or bill validator, or both. In some embodiments, touching the coin return icon results in the vending machine 100 cancelling the initiation of any transaction resulting from reading a credit card into the card validator 112 or accessing a customer's account.

During the vend process, a vend sensing system in the vending machine 100 may indicate to the VMC 150, 800 that the selected product was not successfully dispensed. For example, the product may be stuck in the tray, or the dispensing mechanism corresponding to the product may be inoperative. The status of the vend sensing system is monitored by the VMC 150, 800. If the product is not provided to the customer, the customer may select an icon on the interactive display 125 indicating that the selected product was not dispensed.

If the VMC 150, 800 has not detected, via the vend sensing system, that the vend operation occurred, the vending machine 100 offers the customer the choice of selecting another product, cancelling the transaction and/or obtaining a refund. Additionally the vending machine 100 can be configured to provide a coupon for use during a subsequent vending machine purchase at the vending machine 100 or another vending machine in the vending machine network.

If the VMC 150, 800 has detected, via the vend sensing system, that the vend operation occurred, the vending machine 100 informs the customer via the interactive display 125 and speakers 130 that the product should be in the product delivery bucket 300. The interactive display 125 and speaker 130 also provide the customer with an address or phone number, or both, to contact the operator to obtain a refund if the product was not deposited in the product delivery bucket 300.

In some embodiments, the vending machine 100 provides the customer with a transaction printout that can be used by the operator to determine what occurred and to confirm that the product was not dispensed after the proper amount of money was inserted. The transaction printout can be a message printed by the vending machine 100, transmitted to the customer's account (such as to an email in the customer profile or an inbox in the customer account), or to the customer's cell phone, PDA, or other computer. In some embodiments, the vending machine 100 contacts the operator to report that the vending operation failed.

In yet additional and alternative embodiments, the vending machine 100 is configured to allow the customer to talk to the operator via the interactive display 125. In some embodiments, the vending machine 100 can establish a Voice Over Internet Protocol (VOIP) with the operator. The vending machine 100 informs the customer, via the interactive display 125 and speakers 130, that the operator can be contacted if desired. The customer accepts or denies the contact via one or more icons on the interactive display 125. If the customer selects an accept contact icon, the vending machine 100 contacts the operator. The operator accepts the contact from the vending machine 100. Thereafter, the operator's image can be displayed on the interactive display 125. Further, the camera 135 can capture the customer's image for transmission back to the operator. Thereafter, speakers 130 broadcast messages from the operator while a microphone (not illustrated) receives responses from the customer. The communication can remain until the operator terminates the connection.

One or more of the display functions discussed herein above includes audible alerts or messages broadcast from speakers 130. Accordingly, the vending machine 100 is configured to receive and store audible messages for broadcast via the speakers 130. The audible messages can be stored in one or more of memory 254 in the VMC 150, memory 750 in the computer subsystem 170, memory 850 in the MC 800, or another memory (not specifically illustrated) in the vending machine 100. The computer subsystem 170 (or VMC 800) coordinates audible messages from the speakers 130 and visual messages on the interactive display 125 when necessary.

The vending machine 100 is configured to display advertisements for multiple products and services. When not vending a product, the vending machine 100 can broadcast via interactive display 125 and speakers 130 advertisements related to a product or service. Additionally, the vending machine 100 can broadcast public information such as public service announcements and political advertisements.

In some embodiments, the vending machine 100 can display advertisements during and after a vending transaction. For example, the interactive display 125 can include banner advertisements. Further, the computer subsystem 170 (or VMC 800) can maintain a portion of the interactive display 125 as an advertisement area wherein advertisements are broadcasts continually before, during and after vending transactions.

In some embodiments, multiple vending machines 100 positioned proximate to each other coordinate the broadcast of advertisements and promotional information via their respective interactive displays 125. In such embodiments, the vending machines 100 coordinate images from the interactive displays 125 and sounds from the speakers 130 to form a video wall.

In some embodiments, the operator can mass update a number of vending machines 100 in a vending machine network simultaneously. The operator can perform a mass price change of one or more products in the vending machines in the vending machine network. For example, the operator can use a web-based portal to transmit product pricing to one or more of the vending machines in the vending machine network. The VMC 150 (or computer subsystem 170, or VMC 800) in each of the vending machines 100 in the vending machine network can receive price updates, media updates, and news and weather updates via a number of communication formats including, but not limited to, the internet, a wireline communication, a wireless communication such as Bluetooth®, WiFi, wimax and cellular such as CDMA, TDMA, 3GPP, or any other communication medium.

Using the web-based portal, the operator can transmit (i.e., push) new prices, media information (such as promotional information), and news and weather information to one or more vending machines 100 in the vending machine network 600. The operator can download updated software to the vending machines 100. The operator may mass update all the vending machines 100 in the vending machine network 600 or update selected vending machines 100 in the vending machine network 600.

In general, in accordance with the present disclosure, media information and content is communicated between a remote device (e.g., server, portable device) and the vending machine 100. Media content and controlling information downloaded to the device is stored, and the interactive touch-screen display 125 displays content in accordance with the downloaded information. In other words, a remotely located device enables control and programming of a remote vending machine 100. Content transferred to the vending machine via a communications link is stored, and thereafter, is displayed on the touch-screen display 125 in accordance with the additional information transferred or resident in the vending machine.

In some embodiments, the operator can use the portable device 620 or PDA 645 (e.g., a handheld device) to transfer new prices, media information (such as promotional information and advertisements), and news and weather information to one or more vending machines 100 in the vending machine network 600. Although the above and below embodiments describe functions in relation to the operator, embodiments wherein one of the vending machine manufacturer, product supplier, and product advertiser controls the media information could be used without departing from the scope of this disclosure. The operator can download updated software to the vending machines 100. The operator and mass update all the vending machines 100 in communication with the portable computer 620 or PDA 645 or update selected vending machines 100 in communication with the portable computer 620 or PDA 645.

The operator (e.g., vending machine manufacturer, vending machine operator, product supplier, and product advertiser) can receive sales data and media metrics from the vending machine 100 via the web-based portal, device 635, portable device 620 or PDA 645. The operator also can receive sales data and other vending-specific information, as well as media metrics, from a single machine, or from multiple vending machines or all the vending machines, in the vending machine network simultaneously. The VMC 150 (or computer subsystem 170, or VMC 800) in each of the vending machines 100 in the vending machine network 600 monitors, collects and transmits sales data and other vending-specific information, as well as media metrics to the operator. The sales data includes current product inventories, products sold and quantities of each product sold. Operational status and health information may also be transmitted. The sales data also can include times that each product was sold or time periods when most of the products were sold, or a combination of these. The media metrics includes times when advertisements were played. The media metrics also can include the number of times an advertisement was played (e.g., the number of times a movie trailer was played), and the number of times a customer requested an advertisement be replayed, when a advertisement was played in response to a selection, the number of times and advertisement was stopped from being played, coupons issued (e.g., printed or credited to an account), coupons redeemed, and statistics relating to how the coupons were issued (e.g., in response to winning a game, buying a product, printed versus credited), and the like.

Accordingly, the operator can deliver audio and video content to the vending machine 100 by broadcasting the audio and video content from a central server. The operator can broadcast the audio and video content when the vending machine 100 is not in a transactional mode. In some embodiments, the operator broadcasts the audio and video content at specified times. In some embodiments, the operator broadcasts the audio and video content on an “as needed” basis (e.g., sporadically). In some embodiments, the operator broadcasts a portion of the audio and video content continuously.

The operator can remotely control the audio and video content on a machine-by-machine basis. The operator can broadcast media control information to each vending machine 100 from the central server 635. The media control information can be broadcast individually to each vending machine 100 or collectively to one or more, or all, vending machines 100. The operator can broadcast the media control information when the vending machine 100 is not in a transactional mode. In some embodiments, the operator broadcasts the media control information at specified times. In some embodiments, the operator broadcasts the media control information on an “as needed” basis (e.g., sporadically). In some embodiments, the operator broadcasts the media control information with the audio and video content. The media control information includes scheduling information, display parameters (e.g., full screen, location on the interactive display 125, location within a banner on the interactive display 125, placement within a smaller portion of the interactive display 125 and the like) and sound parameters (e.g., timing, volume, and the like).

The operator can dynamically change product pricing in the vending machine 100 by transmitting a change order from the central server. The operator can broadcast the change order when the vending machine 100 is not in a transactional mode. In some embodiments, the operator broadcasts the change order at specified times. In some embodiments, the operator broadcasts the change order on an “as needed” basis (e.g., sporadically).

The vending machine 100 is configured to display promotions and interactive advertising. For example, the interactive display 125 provides a customer the ability to restart an advertisement, participate in an interactive game, participate in a sweepstakes contest and receive upsells (such as, but not limited to, offers for discounts for additional purchases and offers for discounts when particular products are purchased together). The vending machine 100 can provide the customer with immediate prizes in response to participation in the interactive games and sweepstakes. For example, the vending machine 100 can award products from the product storage area, offer discounts on products in the product storage area, award coupons redeemable in the vending machine 100 or other vending machines 100 in the vending machine network, award coupons redeemable at merchant locations in proximity to the vending machine, award coupons redeemable via the Internet or other associated businesses, or a combination of these.

The vending machine 100 can provide customer interactivity via the customer's cellular telephone. For example, using their cellular telephone, the customer can make purchases from the vending machine 100 or participate in an interactive game with the vending machine 100.

In some embodiments, the vending machine 100 is configured to deliver samples of products to the customer. For example, a vendor may be introducing a new product. The operator places the product in the vending machine 100 and programs the vending machine 100 (e.g., the VMC 150 or 800) to dispense the new product with the purchase of another product. The vending machine 100 then dispenses the new product whenever a customer selects another product. Therefore, every customer receives a “sample” product with their purchases. In some embodiments, the vending machine 100 only dispenses the sample product upon the purchase of one or more specified products. In some embodiments, the vending machine 100 dispenses the sample product when a specified number of products are purchased together. In some embodiments, the vending machine 100 dispenses the sample product when it is determined that the customer has purchased a specified number of products from one or more vending machines 100 in the vending machine network.

In some embodiments, the vending machine 100 can communicate with one or more business using business intelligence software. The vending machine 100 can connect to a bank or other financial institution to facilitate a purchase of a product. The vending machine 100 can connect to a business to facilitate a purchase of a product from the business. Additionally, the vending machine 100 can connect to the financial institution or business to facilitate the payment of a bill by the customer.

In some embodiments, the vending machine 100 vends packaged meals. The meals may be maintained in a heated environment in the cabinet 105 of the vending machine 100. Alternatively, the meals may be maintained in a refrigerated environment in the cabinet 105 of the vending machine 100.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system, comprising:
a remote server configured to transfer media information via a communication link, wherein the media information includes media control information and media content information comprising an advertisement; and
a vending machine, comprising:
a product storage area, configured to store products available for sale from the vending machine;
an interactive display, configured to receive a user selection of a product to vend; and
a controller, configured to:
receive the media information from the remote server via the communication link;
display graphical information relating to the advertisement using the interactive display according to the media information;
receive a product selection signal from the interactive display, the product selection signal representing the user selection of a product to vend; and
dispense a product from the product storage area according to the product selection signal,
wherein the advertisement relates to at least one product available for vending from the vending machine.

2. The system of claim 1, wherein the controller is further configured to:
display the media content information according to the media control information;
collect media metrics information relating the display of the media content information;
send a message to the remote server via the communication link, wherein the message includes the media metrics information.

3. The system of claim 1, wherein the controller is configured to:
receive merchant information via the communication link, the merchant information representing one or more products available from the merchant for purchase;
display graphical information according to the merchant information using the interactive display, the graphical information representing at least some of the one or more products available from the merchant for purchase;
receive a selection signal from the interactive display representing a user selection of a product sold by the merchant; and
send a message via the communication link to purchase the selected product from the merchant.

4. The system of claim 1, wherein the vending machine further comprises a monetary input element, and the controller is configured to:
receive a payment amount from the user via the monetary input element;
receive an identity of a payment recipient from the user via the interactive display; and
send a message via the communication link to transfer the payment amount to the payment recipient.

5. The system of claim 1, wherein the controller is configured to:
display graphical information according to the media information using the interactive display, wherein the graphical information relates to coupons available for dispensing;
receive a coupon selection signal from the interactive display representing a user selection of a coupon to print; and
dispense a coupon according to the coupon selection signal.

6. The system of claim 1, further comprising a second vending machine having a display, wherein the controller of the first vending machine is configured to coordinate display of graphical information according to the media information using the interactive display of the vending machine and the display of the second vending machine.

7. The system of claim 1, further comprising a second vending machine having a display and a controller, wherein:
the remote server is configured to transfer second media information via the communication link;
the controller of the first vending machine is configured to transfer the second media information via a second communication link; and
the controller of the second vending machine is configured to:
receive the second media information from the vending machine via the second communication link; and
display graphical information according to the second media information using the display.

8. The system of claim 1, wherein the controller is configured to:
receive identification information from a user of the vending machine;
send the identification information to a customer account manager associated with the identification information;
receive customer information from the customer account manager; and
based on the customer information, display graphical information according to the media information using the interactive display.

9. The system of claim 1, wherein the controller is configured to:
receive identification information from a user of the vending machine via the interactive display;
send the identification information to a transaction authorizing entity associated with the identification information;
receive transaction authorization information from the transaction authorizing entity; and
based on the transaction authorization information, dispense the product from the product storage area according to the product selection signal.

10. A vending machine, comprising:
a product storage area, configured to store products available for sale from the vending machine;
an interactive display, configured to receive a user selection of a product to vend; and
a controller, configured to:
receive media information via a communication link, wherein the media information includes media control information and media content information comprising an advertisement relating to at least one product available for vending from the vending machine;
display graphical information relating to the advertisement using the interactive display according to the media information;
receive a product selection signal from the interactive display representing the user selection of a product to vend; and
dispense a product from the product storage area according to the product selection signal.

11. The vending machine of claim 10, further comprising a monetary input element, wherein the controller is configured to:
display a coin return icon on the interactive display;
receive a coin return signal from the interactive display representing the user selection of the coin return icon; and
in response to the coin return signal, return money inserted in the monetary input element.

12. The vending machine of claim 10, wherein the controller is configured to display second graphical information according to the media information, based on the product selection signal.

13. The vending machine of claim 10, further comprising a speaker, wherein the controller is configured to broadcast audio information according to the media information using the speaker.

14. The vending machine of claim 10, wherein the controller is configured to control one of a fan and a brightness of the interactive display to reduce an effect on the vending machine of heat produced by the interactive display.

15. The vending machine of claim 10, wherein the controller is configured to:
receive second media information via the communication link;
transfer the second media information to a second vending machine via a second communication link.

16. The vending machine of claim 10, wherein the controller is configured to:
communicate with a second vending machine having a display; and
coordinate display of graphical information according to the media information using the interactive display of the vending machine and the display of the second vending machine.

17. A method comprising:
transferring media information from a remote server to a vending machine via a communication link, wherein the media information includes media control information and media content information comprising an advertisement, the advertisement relating to at least one product available for vending from the vending machine;
displaying graphical information relating to the advertisement using an interactive display of the vending machine, the graphical information displayed according to the media information;
receiving a product selection signal from the interactive display representing a user selection of a product to vend; and
dispensing a product from a product storage area of the vending machine according to the product selection signal.

18. The method of claim 17, further comprising displaying a virtual display of products available for vending from the machine, wherein the user selects a product to vend by touching a representation of the product in the virtual display.

19. The method of claim 18, wherein displaying a virtual display of products comprises emphasizing one or more of the product representations in the virtual display.

20. The method of claim 17, further comprising coordinating display of graphical information according to the media information using the interactive display of the vending machine and a display of a second vending machine.
